(19) United States
(12) Patent Application Publication
(10) Pub. No.: US 2006/0167793 A1
(43) Pub. Date: Jul. 27, 2006

(54) Systems and methods for processing and providing a payment

(76) Inventor: Gernot Sachs, Wiesloch (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/333,264

(22) Filed: Jan. 18, 2006

(30) Foreign Application Priority Data
Jan. 24, 2005 (EP) 05001343.2

(51) Int. Cl. G06Q 40/00

(52) U.S. Cl. 705/40

(57) ABSTRACT

Systems and methods are provided for data processing. In one implementation, a data process system is provided that stores open payment items. Each open payment item may be assigned an identifier. The data processing system may also store user authorizations that specify a sub-set of the identifiers. Furthermore, the data processing system may store user specific totals of payment amounts that have been collected from payers. The data processing system may report receipt of an open payment item, add the open payment item to a user specific total, and initiate a transfer of the user specific total from a payer's bank account to a payee's bank account.

### CROSS-REFERENCE TO RELATED APPLICATION

This application is based upon and claims the benefit of priority from European Patent Application No. EP 05001343.2, filed Jan. 24, 2005, the entire contents of which are expressly incorporated herein by reference.

### DESCRIPTION

I. Technical Field

The present invention generally relates to the field of data processing. More particularly, and without limitation, the invention relates to systems and methods for processing and collecting open payment items.

II. Background Information

The insurance service industry expends large amounts of resources, including facilities, equipment and staff, to collect unpaid insurance premiums. Moreover, the collection process often includes the use of outside collection agencies. For example, U.S. Pat. No. 5,991,733, entitled “Method and Computerized System for Managing Insurance Receivable Accounts,” discloses a computerized method for managing insurance receivable accounts. The method provides a combination of specific automation enablers and unique ruled based decision tools which are used to maximize recovery of the insurance receivable accounts. The method includes automation of collection strategies based in part on an automated decision support tool for objective evaluation of data relating to any collection related decisions or activities, and a historical data warehouse that is used to compare other recorded insurance receivable accounts. The computerized system comprises a local area network including workstations, database server, file server, input devices, and output devices that are configured by software to accumulate, process, administer, and analyze premium insurance collection accounts in an automated workflow process environment. The computerized system provides, among other capabilities, for cases processed in-house by collectors, automation respecting scripted dispute handling, on-line payment plan capabilities, electronic data transfer, and collection strategy development for cases that are referred to an outside collection agency or attorney. The system also provides automation for facsimile generations, legal strategy development, in-house attorney reviews and monitoring, electronic data transfers to local counsel, evaluation of the next step to be undertaken, and access to a bankruptcy database.

Other conventional methods are disclosed in U.S. Pat. No. 5,444,615, entitled “Attorney Terminal Having Outline Preparation Capabilities For Managing Trial Proceeding,” which describes attorney terminals having outline capabilities for storing managing case evidence, case law, and work product materials. In addition, U.S. Pat. No. 5,136,502, entitled “System For Funding, Analyzing And Managing Health Care Liabilities,” discloses a system for funding and managing retiree health care benefits. As yet another example, U.S. Pat. No. 5,191,522, entitled “Integrated Group Insurance Information Processing And Reporting System Based Upon An Enterprise-Wide Data Structure,” discloses an integrated information processing storage system for processing and supervising a plurality of group insurance accounts. As still yet another example, U.S. Pat. No. 4,831,526, entitled “Computerized Insurance Premium Quote Request And Policy Issuance System,” discloses a computerized system for processing and preparing applications for insurance and premium quotations and for preparing and writing insurance contracts.

A common disadvantage of known computer systems for collecting such payments is the lack of seamless interaction between the insurance company's computer system and the outside collection agency's computer system. Similar problems exist in other industries, such as the utility and telecommunication industries, that collect payments for gas, electricity or telecommunication charges. Therefore, to more efficiently and effectively manage the payment collection process, there is a need for systems and methods that provide a seamless interaction between, for example, an insurance company and outside collection agency.

### SUMMARY

Embodiments consistent with implementations of the present invention provide data processing systems and methods. The data processing system may include means for storing open payment items, wherein each open payment item being assigned to an identifier. Further, the data processing system may include means for storing user authorizations, where each user authorization specifies a sub-set of the identifiers. The data processing system may store user specific totals of payment amounts that have been collected by the users from payers. The data processing system may also include communication means adapted for receiving a user selection of one of the identifiers of the sub-set of identifiers of the user's user authorization, retrieving the respective open payment item, transmitting the open payment item to the user's client device, and receiving data indicative of the user's receipt of the open payment item from the payer. The open payment item for which payment has been received may be added to the user specific total. A transfer of the user specific total from the user's bank account to a payee's bank account may be initiated. After the initiation of the transfer, the user specific total may be reset.

By way of example, each identifier may be assigned to a specific contract. The contract may specify a payment amount and due dates for the payments, such as regular payments of premiums due for an insurance contract. Respective open items may be stored in the data processing system.

Embodiments consistent with the present invention may facilitate the use of outside collection agencies or agents to collect payments for open payment items. The outside collection agency or agent may have an assigned user authorization that specifies a sub-set of the identifiers. In other words, the set of all contracts may be split into sub-sets and the sub-sets may be assigned to different users in order to establish a network of collection agencies or agents. Accordingly, each collection agency or agent may have a well defined scope of responsibility for collecting open payment items for the respective sub-set of contracts.

Consistent with embodiments of the present invention, payments that are collected by a specific collection agency or agent may be summed for each collection agency or agent individually. The total amount of reported payments that have been received by the collection agency or agent may be transferred from a bank account of the collection agency or agent to a payee's bank account. For example, the bank transfer may be initiated after the end of each business day, at periodic intervals, or when the total amount of reported payments has reached an upper threshold level. After the bank transfer has been initiated, the respective user specific total may be reset to zero and the aggregation of the reported payments may be restarted until a new bank transfer is initiated, for example.

Consistent with an embodiment of the present invention, each collection agency or collection agent may have one or more sub-collection agencies or agents to which the main collection agency or agent may delegate a sub-set of payments to be collected. The payments collected by the sub-collection agencies or sub-agents may be aggregated together with the payments collected by the main collection agency or agent and the total amount of the payments collected by the main collection agency/agent and its sub-collection agencies/agents may be deducted from the bank account of the main collection agency/agent. The money transfer of payments collected by the sub-collection agencies/agents to their respective main collection agency/agent may be performed in various ways and may be implemented with or without the data processing system.

Consistent with another embodiment of the present invention, reporting of payments received by an outside collection agency/agent or sub-collection agency/agent may be performed using a web-portal. For example, a standard browser program, such as Microsoft Internet Explorer or Netscape Navigator, may enable the accessing of web-portal functionalities. The web-portal may provide a data entry field for entering a user's selection of one of the contract identifiers. In response, open payment items for the selected contract may be retrieved and displayed. After the user (i.e., the outside collection agency or agent) has received the respective payment, receipt is reported to the data processing system by entering respective data using the web-portal.

Consistent with another embodiment of the present invention, selection of one of the contracts may be facilitated by means of a pull-down menu that only contains identifiers of the sub-set of identifiers within the scope of the user's authorization.

According to yet another embodiment of the present invention, the web-portal may provide a virtual cash journal for each user and for each sub-user, if any, to facilitate collection of payments in the form of cash and/or checks.

It is to be noted that the present invention can be used for the collection of open payment items in various industries. For example, implementations of the present invention may collect insurance premiums, utility invoices, such as payments of gas, electricity or telecommunication charges, or other payments that are due at regular or irregular intervals and are collected by a network of outside collection agencies and/or sub-agencies or agents.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary data processing system, consistent with an embodiment of the present invention;

FIG. 2 is a flowchart illustrating an exemplary method, consistent with an embodiment of the present invention;

FIG. 3 is a flowchart illustrating another exemplary method, consistent with an embodiment of the present invention; and

FIG. 4 shows an exemplary window generated by a web-portal for a user to report received payments, consistent with an embodiment of the present invention.

### DETAILED DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

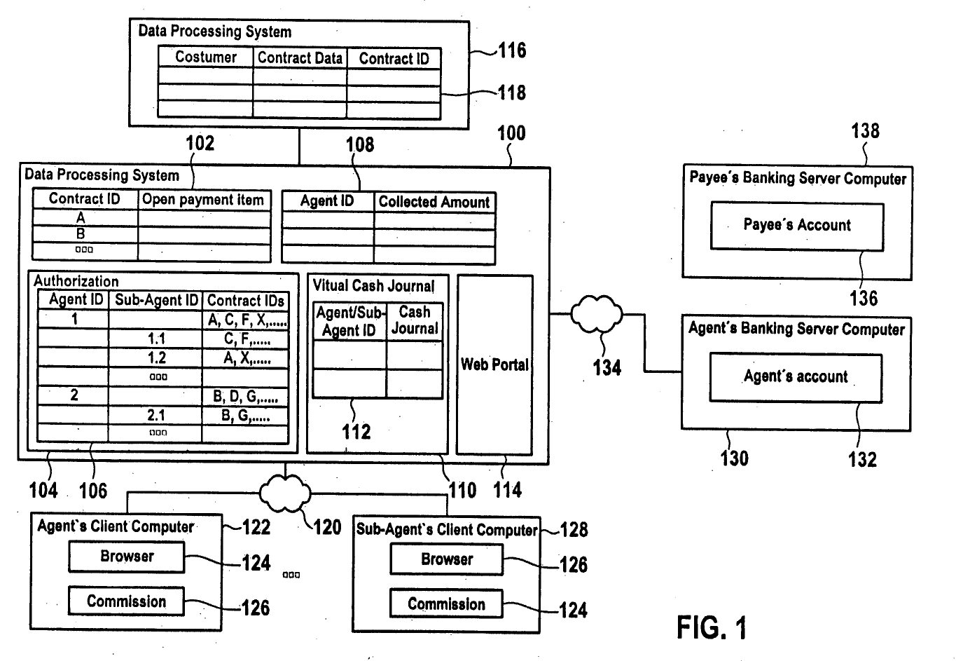

FIG. 1 is a block diagram of an exemplary data processing system 100 that may act as a virtual hub for collecting open payment items and providing the collected payments to a payee. Data processing system 100 includes a database table 102 that contains a number of identifiers and open payment items that are assigned to the identifiers. For example, each identifier may unequivocally identify a specific contract that exists between the payee and a payer. An open payment item that has become due for the contract identified by a given identifier is assigned to that identifier in the database table 102. Data processing system 100 also includes an authorization component 104 for storing user authorizations. Users of data processing system 100 may include outside collection agencies or outside collection agents, or sub-collection agencies/agents. Database table 106 of the authorization component 104 may specify sub-sets of the contract identifiers stored in database table 102 for the various agencies/agents. As used herein, the term “agent” may relate to outside collection agencies and/or outside collection agents.

For example, one of the agents may be assigned agent identifier (ID) “1”. A number of contract identifiers (IDs) may be assigned to the agent ID “1”, such as contract IDs A, C, F, X, etc., for example. The agent with the agent ID “1” may have a number of sub-agents. For example, one of the sub-agents of agent “1” has the sub-agent ID “1.1”. A sub-set of the sub-set of contract IDs assigned to the agent “1” may be assigned to the sub-agent “1.1” in the database table 106, i.e. contract IDs C, F, etc., for example. Similarly, another sub-set of the sub-set of contract IDs assigned to the main agent “1” may be assigned to another sub-agent “1.2”, i.e. A, X, etc., for example. Similarly, other sub-sets of contract IDs may be assigned to other agents and sub-agents such as agent “2” and sub-agent “2.1,” as shown in FIG. 1.

Furthermore, data processing system 100 may include a database table 108 for storing user specific totals of payment amounts that have been collected by respective users (i.e., agents) from payers. The “collected amount” that is assigned to a given agent ID in database table 108 may be the accumulated payment amount that was collected by the respective agent (i.e., the total of all payments collected after the “collected amount” had been reset). After determining the “collected amount,” a respective open payment item is created for the agent that has performed the collection of the payments in database table 102.

Data processing system 100 may also include a virtual cash journal component 110. The virtual cash journal component 110 may provide a virtual cash journal for each registered agent and/or sub-agent. For example, virtual cash journal component 110 may include a database table 112 that contains virtual cash journal data assigned to the agent ID or sub-agent ID of the respective agent's or sub-agent's cash register. For example, the virtual cash journal data may include postings of received cash or check payments and postings of amounts taken from the cash register by the agent or sub-agent. Furthermore, the virtual cash journal data may include the cash balance of the respective agent's or sub-agent's cash register.

Data processing system 100 may include a web-portal component 114 to provide a web-portal for interacting with the agent's and sub-agent's client computer systems.

As further shown in FIG. 1, data processing system 116 may be coupled to data processing system 100. Data processing system 116 may include a database table 118. Database table 118 includes customer master data, such as customer name and address and contract data, e.g., a payment amount and due dates when the payment amount becomes due to be paid to the customer's contract partner (i.e., the payee or the payee's collection agent). Each contract may be assigned an identifier that unequivocally identifies the contract within the complete set of contracts administered by data processing system 116. Contract data that is necessary for identification of open payment items may be exported from data processing system 116 to data processing system 100. For example, using the contract data, data processing system 116 may generate the database table 102 that contains the open payment items for the various contracts. Collection of payments from the customers of the payee may be performed by a network of agents and sub-agents. The communication between the agents and data processing system 100 may be performed via a computer network 120, such as the Internet.

For example, an agent with agent ID “1” may use a client computer 122 to connect to web-portal 114 via computer network 120. For example, this may be implemented using a standard browser program 124 executing on client computer 122 in order to avoid a need for special software. Optionally, client computer 122 may include a program component 126 for calculating the agent's commission for the collection of reported payments. Alternatively, the functionality of program component 126 may be integrated into web-portal 114 in order to avoid a need to install program component 126 on each client computer. In the example considered herein, sub-agent “1.1” of agent “1” may use a client computer 128, which has substantially the same design as client computer 122.

Data processing system 100 may be coupled to banking server computers of the various agents in order to transfer the collected amount of payments that have been collected by an agent to the payee's account. As shown in FIG. 1, a banking server computer 130 of, for example, agent's “1” bank runs the agent's bank account 132. Data processing system 100 may be coupled to banking server computer 130 via a computer network 134, which may or may not be identical to computer network 120.

Data processing system 100 may send a request to banking server computer 130 to transfer the collected amount of payments in order to transfer the collected amount from the agent's bank account 132 to the payee's bank account 136 that may be maintained by a banking server computer 138 of the payee's bank. Typically, the agent's commission for the collected payments is deducted from the collected amount. This may be implemented by the data processing system 100 or via the agent's client computer when payments are reported.

Data processing system 100 may include a reallocation component (not shown) to temporarily or permanently reassign a contract or a set of contracts from one agent to another. For example, the reallocation component may temporarily assign the contracts of agent “1” to agent “2” when agent “1” is on vacation, for example.

Any commissions payable by the payee to the agents and/or any commissions payable by an agent to its sub-agent may be determined by data processing system 100 or by another data processing system (not shown) coupled to data processing system 100. For example, data processing system 100 may receive the commission amounts assigned to specific agents or sub-agents from the other data processing system. Furthermore, the agent's commission reduces the payment amount to be transferred from the agent's bank account 132 to the payee's bank account 136.

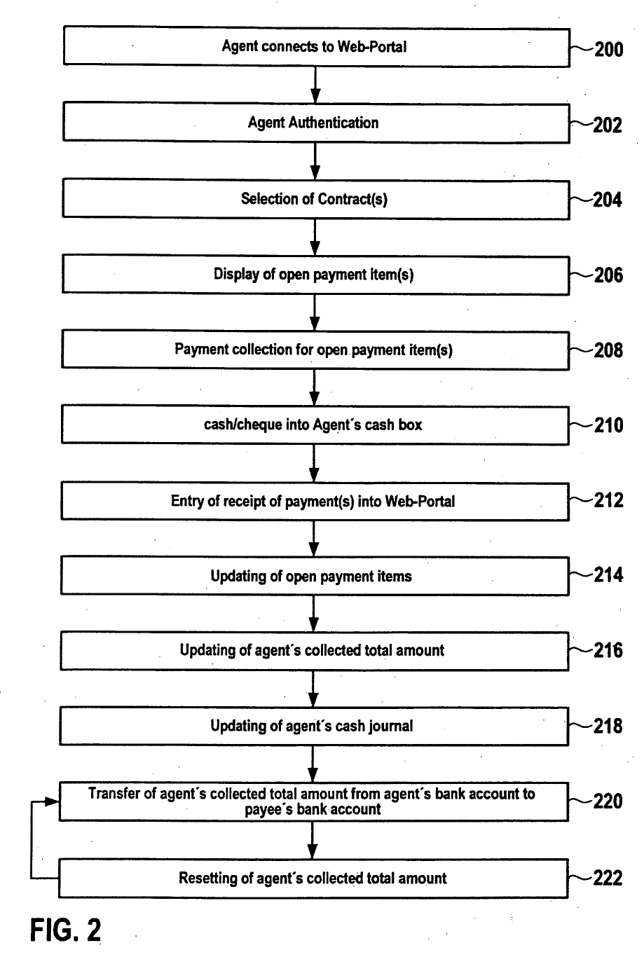

FIG. 2 is flow diagram of an exemplary method, consistent with an embodiment of the invention. For purposes of illustration, the exemplary method will be described with reference to operation of data processing system 100 of FIG. 1. In step 200, one of the agents connects to the web-portal by means of his or her client computer. In step 202, the agent is authenticated, such as by entering his or her password and user ID. Next, in step 204, the agent selects one or more contracts. Selection may occur by manually entering the respective contract IDs or by selecting the contracts from a pull-down menu. For example, the pull-down menu may only contains those contracts or contract IDs that are within the scope of responsibility of a particular agent as specified in database table 106.

In response to the agent's selection of one or more of the contracts, open payment items that are due for payment may be retrieved from database table 102 and be displayed on the agent's client computer. (Step 206). In step 208, the agent may collect the payment or payments for the open payment item or items from the payee's customer. Next, the agent may place the respective cash or check payment into his or her cash box or cash register. (Step 210). In step 212, the agent may report the receipt of the payment or payments using the web-portal. In response, the web-portal may post the reported payments and update database table 102 with respect to the open payment items correspondingly. (Step 214). In step 216, the total payment amount collected by the agent is updated by adding the total amount of the payments received in step 208 to the collected amount stored in database table 108 for the agent. The agent's commission may be deducted from the total collected amount. Furthermore, the cash or check payment received by the agent in step 210 may be posted in the agent's virtual cash journal (i.e., database table 112). (Step 218).

Steps 200 to 218 may be repeated several times during a business day. In addition, at the end of a business day, step 220 may be performed to transfer the total collected payments for the business day and that have been reported using the web-portal from the agent's bank account to the payee's bank account. Then, in step 222, the agent's selected amount stored in database table 108 is reset to zero.

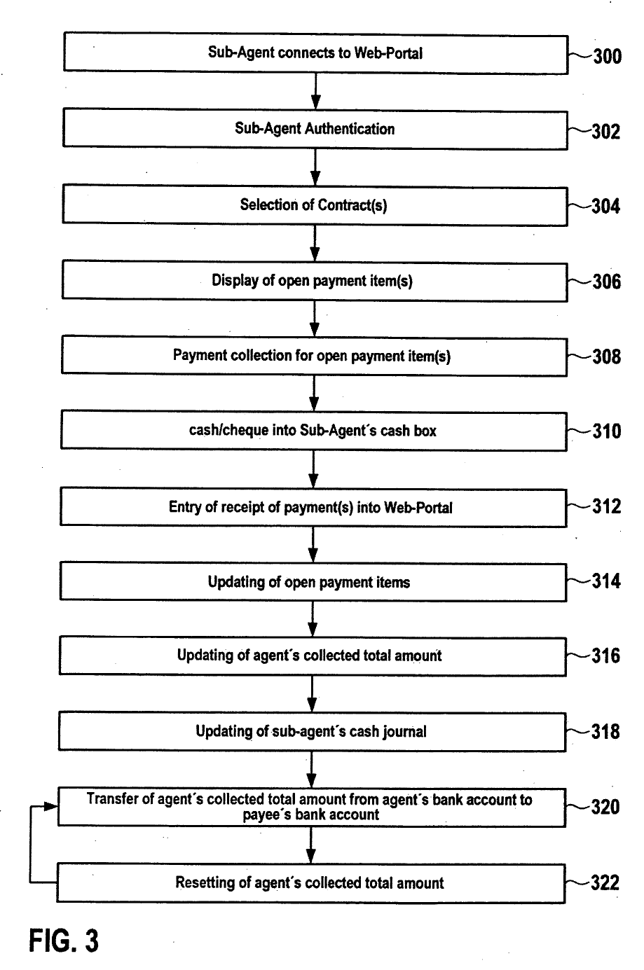

FIG. 3 is a flow diagram of an exemplary method with respect to a sub-agent. In step 300, the sub-agent connects to the web-portal. Steps 302 to 314 are analogous to the steps 202 to 214 of FIG. 2. Next, in step 316 the total amount of the payments collected by the sub-agent is added to the main agent's collected total amount. In other words, there is no separate aggregation of the sub-agent's collected total amounts but only a single collected amount for the main agent and its one or more sub-agents. Accordingly, step 318 is analogous to step 218 whereas steps 320 and 322 are analogous to steps 220 and 222, respectively, except that the total collected amount does also contain payments collected by the sub-agents in addition to the payments collected by the agent.

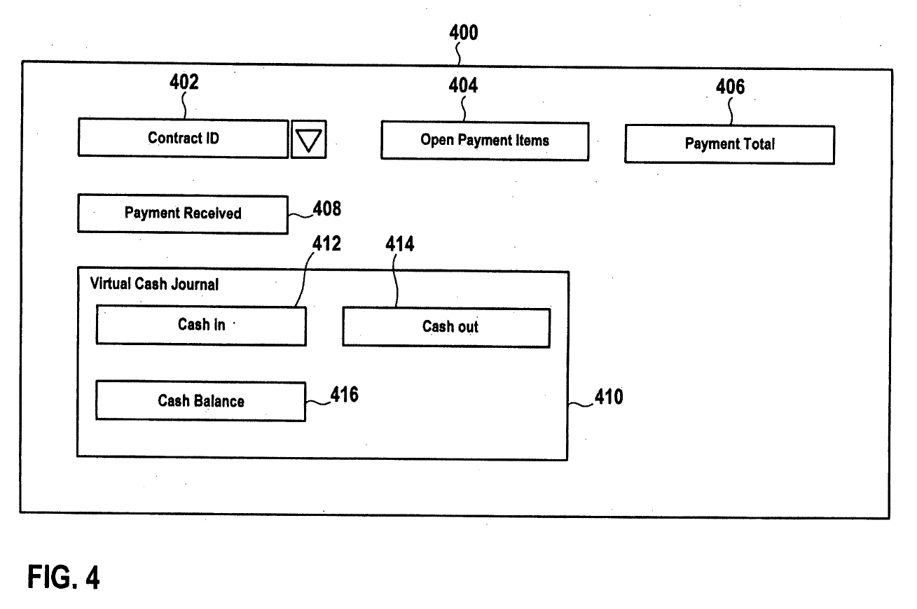

FIG. 4 shows an exemplary window 400 of a browser of an agent or sub-agent client computer (e.g., browser program 124 as shown in FIG. 1). Window 400 includes a pull-down menu 402 that the agent may use to select one or more contract IDs. Window 400 also includes a data field 404 to display open payment items of the selected contracts and a data field 406 to display the total open payment items that are shown in data field 404. When the agent receives the payment total from the customer (i.e., the payer), the agent may click on virtual button 408 to report receipt of the payment using the web-portal. In response, the web-portal may clear the respective open payment item or items from the database table (for example, database table 102 of FIG. 1). Alternatively, a contract may be selected by entering the contract ID via a keyboard.

Window 400 may also include a field 410, which provides a virtual cash journal for the agent. Field 410 may include a data entry field 412 that the agent may use to enter a cash amount or the amount of a check that has been received by the agent. Furthermore, field 410 may include a data entry field 414 that the agent may use to enter an amount taken from a cash box or cash register by the agent. Data field 416 shows the current cash balance, which should match the total cash and checks that are currently in the cash box or cash register of the agent.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets or in SAP R/3 or ABAP. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A data processing system, comprising:
means for storing open payment items, wherein each open payment item is assigned to an identifier;
means for storing user authorizations, wherein each user authorization specifies a sub-set of the identifiers;
means for storing user specific totals of payment amounts that have been collected from payers;
communication means for receiving a selection of one of the sub-sets of the identifiers, accessing the means for storing the open payment items with the selected identifier to retrieve the open payment item assigned to the selected identifier, transmitting the retrieved open payment item to a client device, and receiving data indicating receipt of the open payment item from a payer;
means for adding the open payment item to a user specific total;
means for initiating a transfer of the user specific total from a bank account of the user to a payee's bank account; and
means for resetting the user specific total after the transfer has been initiated.

2. The data processing system of claim 1, wherein the selected identifier is a contract identifier that identifies a contract between the payer and the payee and the contract specifies a payment amount and a due date for paying the payment amount, the data processing system further comprising:
a database for storing the payment amount and the due date specified by the contract.

3. The data processing system of claim 1, wherein the means for storing user authorizations stores sub-user authorizations and each sub-user authorization specifies a sub-set of the sub-set of identifiers of a user.

4. The data processing system of claim 3, wherein one of the user specific totals contains aggregated payment amounts collected by a user and the one or more sub-users of the user after a corresponding user specific total is reset.

5. The data processing system of claim 1, wherein the communication means comprises a web-portal.

6. The data processing system of claim 5, wherein the web-portal generates a pull-down menu for selecting one of the identifiers of the sub-set of the identifiers specified by a corresponding user authorization.

7. The data processing system of claim 5, wherein the web-portal provides a virtual cash journal to each user.

8. The data processing system of claim 5, wherein the web-portal provides a virtual cash journal to each sub-user.

9. The data processing system of claim 1, wherein the means for initiating transfers of the user specific total initiates the transfer at a pre-determined time or within pre-programmed intervals.

10. A method of providing payment, comprising:
storing open payment items, wherein each open payment item is assigned to an identifier;
storing user authorizations, wherein each user authorization specifies a sub-set of the identifiers;
storing user specific totals of payment amounts that have been collected from payers;
receiving a selection of one of the sub-sets of identifiers;
accessing open payment items with the selected identifier to retrieve the open payment item assigned to the selected identifier;
transmitting the retrieved open payment item to a client device;
receiving data indicating receipt of the open payment item from a payer;
adding the open payment item to a user specific total;
initiating a transfer of the user specific total from a bank account of the user to a payee's bank account; and
resetting the user specific total after the transfer has been initiated.

11. The method of claim 10, wherein the selected identifier is a contract identifier that identifies a contract between the payer and the payee and the contract specifies a payment amount and a due date for paying the payment amount, the method further comprising:
storing the payment amount and the due date specified by the contract in a database.

12. The method of claim 10, further comprising:
storing sub-user authorizations, wherein each sub-user authorization specifies a sub-set of the sub-set of identifiers of the respective user.

13. The method of claim 12, wherein the open payment item is added to the user specific total.

14. The method of claim 10, wherein a web-portal receives the selection, transmits the open payment item, and receives data confirming receipt of the open payment item.

15. The method of claim 10, further comprising:
providing a virtual cash journal to each user.

16. The method of claim 10, further comprising:
subtracting a commission for an agent or a sub-agent from a collected amount before transferring the collected amount from a bank account of the agent or the sub-agent.

17. A method of collection of payments, comprising:
connecting a client device to a web-portal;
selecting an identifier from a sub-set of identifiers displayed on a pull-down menu, wherein each identifier is assigned a payment item;
displaying an open payment item assigned to the selected identifier; and
receiving data confirming receipt of the open payment item from a payer.

18. The method of claim 17, further comprising:
recording receipt of the open payment item in a virtual cash journal that is provided by the web-portal.
